(19) United States
(12) Patent Application Publication
(10) Pub. No.: US 2026/0351967 A1
(43) Pub. Date: Nov. 5, 2026

(54) SYSTEMS AND METHODS FOR PROVIDING ELECTRICAL POWER FROM A VEHICLE TO AN EXTERNAL LOAD

(71) Applicant: Ford Global Technologies, LLC, Dearborn, MI (US)

(72) Inventors: Shannon Wrobel, Ann Arbor, MI (US); Andrew Mast, Northville, MI (US)

(21) Appl. No.: 19/198,848

(22) Filed: May 5, 2025

(51) Int. Cl. H02J 3/0012; H02J 3/00; H02J 3/32; H02J 105/42

(52) U.S. Cl. CPC H02J 3/0012; H02J 3/003; H02J 3/004; H02J 3/322; H02J 2105/42

(57) ABSTRACT

Methods and systems are provided for providing electrical power from a vehicle to an external load. In one example, a method may include automatically preparing the vehicle for electrical power transfer from the vehicle to the external load and automatically alerting the user when a power outage to the external load is determined, flowing electrical power from the vehicle to the external load while monitoring an amount of available vehicle energy, and automatically stopping flow of electrical power from the vehicle to the external load when the amount of available vehicle energy falls below a threshold vehicle energy or when an end of the power outage is determined.

### FIELD

The present description relates generally to providing electrical power from a vehicle to an external load.

### BACKGROUND/SUMMARY

In some scenarios, there may be loss of electrical power due to infrastructure degradation or interruption, for example. Lack of electrical power supply from the electrical grid may reduce use of household appliances such as heating ventilation and cooling (HVAC), refrigerators, cooking appliances (e.g., stove, oven, microwave, etc.), lights, and more. Unless preinstalled prior to the power outage, local power alternatives, such as generators, may be limited. Further, generators tend to be heavy and difficult to move following installation, limiting flexibility in the devices that can be powered by the generator according to their physical locations.

In one example, the issues described above may be addressed by a method for providing electrical power to an external load from a vehicle, comprising: automatically preparing the vehicle for electrical power transfer from the vehicle to the external load and automatically alerting a user when a power outage to the external load is present; electrically coupling the external load to the vehicle; flowing electrical power from the vehicle to the external load while monitoring an amount of available vehicle energy and a predicted power demand of the external load; and automatically stopping flow of electrical power from the vehicle to the external load when the amount of available vehicle energy falls below a threshold vehicle energy based on a travel distance to repower the vehicle.

In this way, electrical power from the vehicle may be supplied to the external load as the controller of the vehicle monitors the predicted end time of the power outage, the available vehicle energy, and the available duration.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example system for providing electrical power from a vehicle to an external load.

FIGS. 2A and 2B show a flowchart of a method for providing electrical power from a vehicle to an external load.

FIG. 3 shows an example timeline diagram over a duration of providing electrical power from a vehicle to an external load.

### DETAILED DESCRIPTION

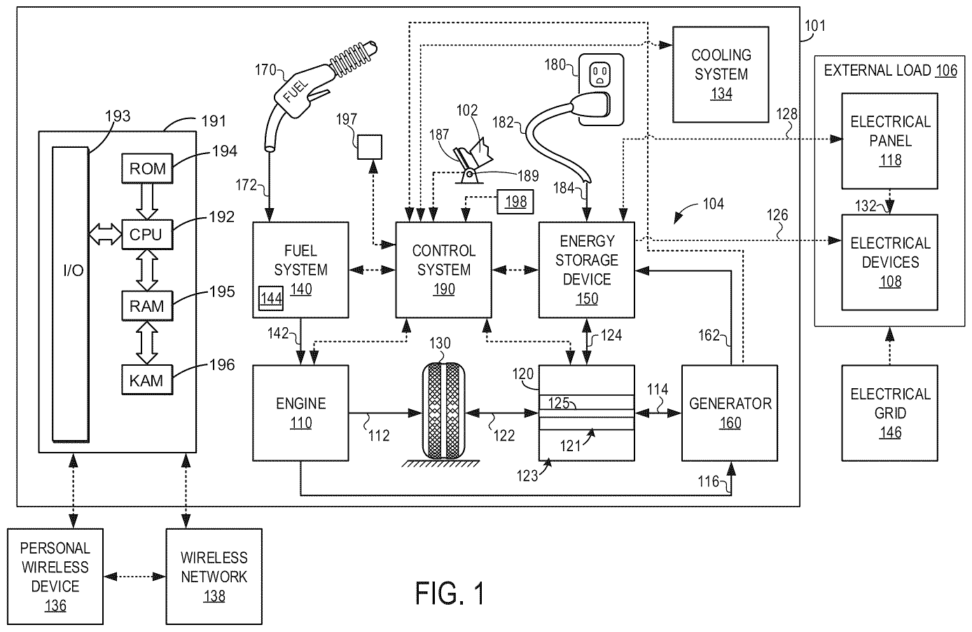

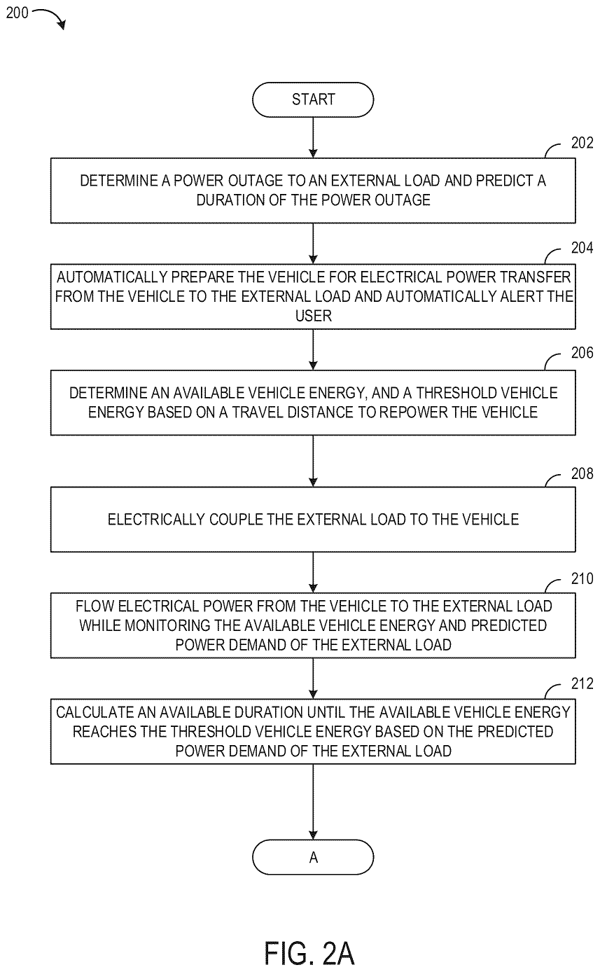

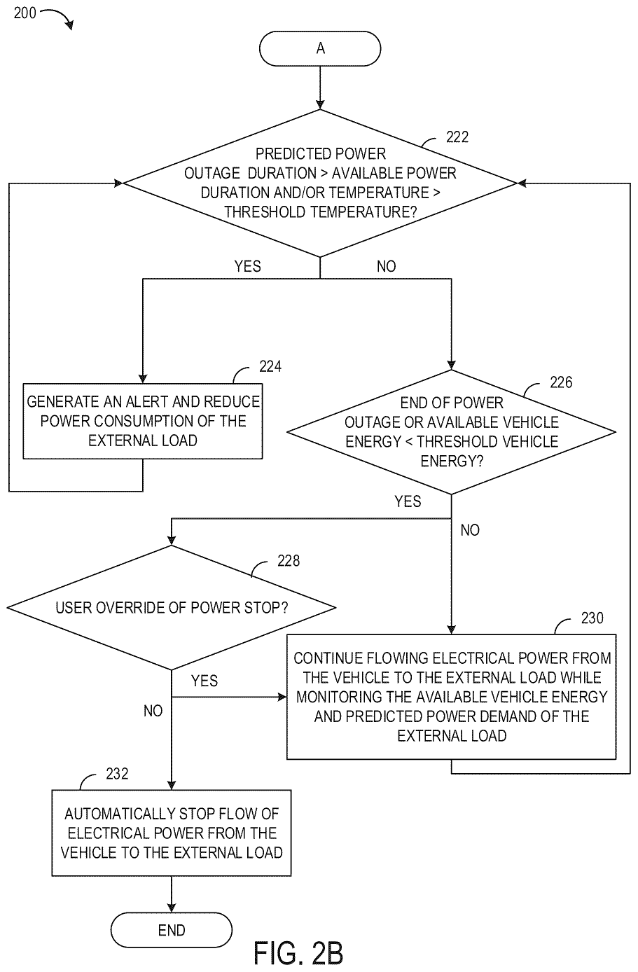

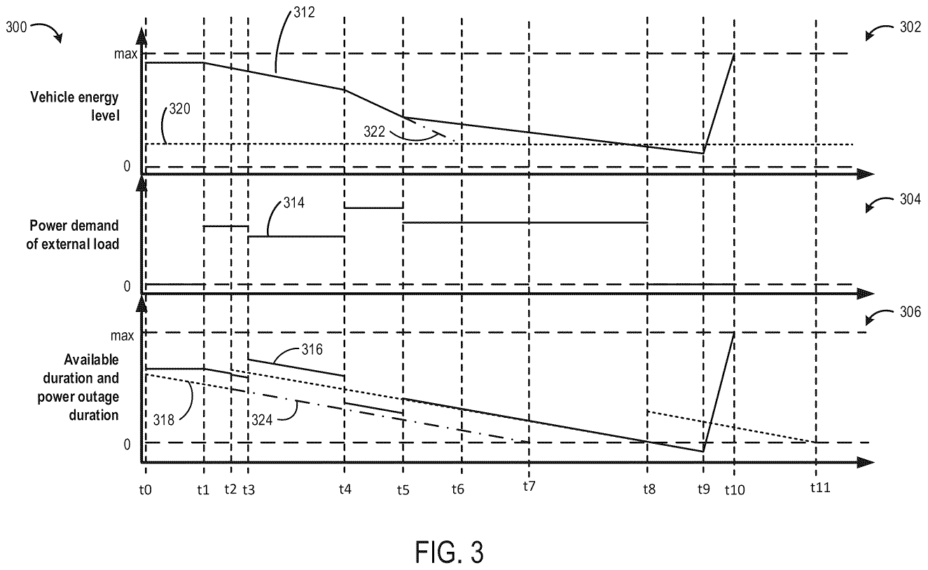

The following description relates to systems and methods for providing electrical power from a vehicle to an external load. FIG. 1 schematically illustrates a system including a vehicle and an external load which may be powered by the vehicle during a power outage to the external load (e.g., loss of power available from the electrical grid). Methods are shown as flow charts in FIGS. 2A and 2B for powering the external load with energy from the vehicle. The methods include automatically preparing the vehicle for power transfer (e.g., by automatically activating cooling systems in response to detecting the power outage to the external load, switching circuit breakers and/or contactors within the vehicle, etc.), and automatically reacting to conditions, such as an available vehicle energy of the vehicle (e.g., energy stored in the vehicle as fuel and/or battery charge) falling below a threshold vehicle energy demanded to propel the vehicle from the current location (e.g., in proximity to the external load) to the nearest place to repower (e.g., refuel and/or recharge) the vehicle. As an example, the vehicle may automatically stop or reduce power flow to the external load in response to such conditions, to reduce a likelihood of draining the available vehicle energy of the vehicle below a threshold vehicle energy demanded to travel a distance to repower (e.g., refuel and/or recharge) the vehicle. The controller of the vehicle may monitor (e.g., periodically calculate and/or predict) several variables including one or more of the available vehicle energy, power demand of the external load, and available duration (e.g., time before the available vehicle energy reaches the threshold vehicle energy) according to feedback received from sensors of the vehicle. The methods may further include receiving user input that is used to predict metrics such as the predicted power demand of the external load, as well as generating alerts provided to a user of the vehicle to provide instructions prior to power flow on electrically coupling the vehicle to the external load according to available equipment (e.g., transfer switch, cables, etc.) and/or composition of the external load (e.g., types of electrical devices and/or systems to be powered), to notify the user of events of interest such as an increase or decrease in power consumption of the external load during power flow, and/or to recommend to the user to reduce power demand of the external load in response to the available vehicle energy falling below the threshold vehicle energy. A timeline diagram is shown in FIG. 3 for an example of changes in monitored variables (e.g., available vehicle energy, predicted power outage duration, power consumption of the external load, and the like) during a period of time where the external load experiences a power outage.

In this way, electrical power from the vehicle may be supplied to the external load as the controller of the vehicle monitors the predicted end time of the power outage, the available vehicle energy, and the available duration. Unlike other alternative energy sources, the vehicle may not demand manual installation prior to the occurrence of the power outage. Instead, preparing the vehicle to supply electrical power (e.g., by activating cooling systems) may be initiated in response to detection of the power outage. For example, the preparations may be initiated automatically, or in response to user input such as selection of auto remote start responsive to an alert generated automatically in response to detection of the power outage. The user may then electrically couple the vehicle to the external load in response to an alert generated at the time of detection of the power outage. Automatically preparing the vehicle prior to flowing power from the vehicle to the external load may prime various systems of the vehicle to reduce (e.g., prevent) degradation to the vehicle and increase efficiency (e.g., efficiency of energy conversion between mechanical and electrical forms). Further, the mobility of the vehicle and ability of the vehicle to electrically couple to the external load in various ways (e.g., transfer switch, bidirectional power transfer, direct plug into appliances, etc.) may expand the variety of electrical devices that may be powered by the vehicle. Further still, monitoring and displaying the predicted power outage duration and the available vehicle energy may provide the user with an estimated power supply capability of the vehicle in real-time. Moreover, in some examples, automatically reacting to conditions, such as the predicted power outage duration being shorter than the available duration or the available vehicle energy being less than the threshold vehicle energy, may allow the vehicle to self-control power flow to the external load such that electrical energy is available to the external load throughout the power outage. Additionally or alternatively, automatically reacting to such conditions may include generating an alert that is displayed to a user, wherein contents of the alert comprise a recommendation to reduce power by taking actions such as decoupling a device from the vehicle, powering off the device, etc. Automatically generating alerts to the user in response to such conditions may also inform the user of suggested steps to electrically couple the desired external load according to available systems to reduce likelihood of degradation to the vehicle and external load, prolong the available duration, and plan for repowering of the vehicle if demanded prior to the expected end of the power outage.

Due to the controller including instructions stored in non-volatile memory thereof being executable to automatically prepare the vehicle for power transfer in response to detecting a power outage to the external load and automatically respond to conditions during power transfer, the vehicle may provide a mobile form of energy supply to the external load which does not demand preinstallation (e.g., set up prior to the power outage), and control of power flow to prolong the available power supply duration enough to reach the predicted end of the power outage. For example, control of power flow may be automatic such that the vehicle self-controls the rate of electrical energy leaving the vehicle. As another example, the controller may automatically generate alert(s) displayed to the user prompting the user to take action(s) that manages the power flow such as manually reducing the power consumption of the external load.

Turning now to the figures, FIG. 1 illustrates an example of a system 100 wherein electrical power may be provided to an external load 106 by a vehicle 101 including a vehicle propulsion system 104. For example, in response to a power outage to the external load 106 (e.g., loss of electrical power provided from an electrical grid 146 to the external load 106) such as during a natural situation in the geographical region where the vehicle 101 and the external load 106 are located in which land power infrastructures are degraded, a user of the vehicle may choose to power the external load 106 with electrical energy generated by the vehicle 101 as described further below.

The vehicle propulsion system 104 includes a fuel burning engine 110 and/or an electric machine 120. As a non-limiting example, the engine 110 may be an internal combustion engine (ICE). Further, in a non-limiting example, the electric machine 120 may be a traction motor. The electric machine 120 may include a rotor assembly 121 and a stator assembly 123 that electromagnetically interact to generate rotational output. The rotor assembly 121 may include a rotor shaft 125 that is coupled to a downstream powertrain component. Electric machine 120 may propel the vehicle via the drive wheel 130 as indicated by arrow 122. Likewise, engine 110 may propel the vehicle via the drive wheel 130 as indicated by arrow 112. The engine 110 may be operated by combusting or otherwise consuming fuel received from a fuel system 140 as indicated by arrow 142. Note that in some embodiments, the electric machine 120 may propel the vehicle via a first set of drive wheels and the engine 110 may propel the vehicle via a second set of drive wheels.

Electric machine 120 is configured to utilize or consume a different energy source than engine 110. For example, engine 110 may consume a fuel (e.g., gasoline, natural gas, hydrogen, etc.) to produce an engine output while electric machine 120 consumes electrical energy to produce a motor output. As such, the vehicle 101 with the propulsion system 104 may be a hybrid electric vehicle (HEV). In the hybrid vehicle example, the traction motor and the engine may have a variety of suitable architectures. However, in other examples, the vehicle may be an ICE vehicle where the powertrain includes the engine as the sole propulsion source. In other examples, the vehicle 101 may be an all-electric vehicle where the powertrain includes one or more traction motors as the propulsion source.

The electric machine 120 may be operated to charge the energy storage device 150. For example, the electric machine 120 may receive wheel torque from drive wheel 130 as indicated by arrow 122 where the motor may convert the kinetic energy of the vehicle to electrical energy for storage at the energy storage device 150 as indicated by arrow 124. This operation may be referred to as regenerative speed reduction of the vehicle. Thus, the electric machine 120 can provide a generator function in some embodiments. However, in other embodiments, a generator 160 may instead receive wheel torque from the drive wheel 130, where the generator may convert the kinetic energy of the vehicle to electrical energy for storage at the energy storage device 150 as indicated by arrow 162.

In other embodiments, vehicle propulsion system 104 may be configured as a series type vehicle propulsion system, whereby the engine does not directly propel the drive wheels. Rather, the engine 110 may be operated to power the electric machine 120, which may in turn propel the vehicle via drive wheel 130 as indicated by arrow 122. For example, during select operating conditions, the engine 110 may drive the generator 160 as indicated by arrow 116, which may in turn supply electrical energy to one or more of the electric machine 120 as indicated by arrow 114 or energy storage device 150 (e.g., a battery) as indicated by arrow 162. As another example, the engine 110 may be operated to drive the electric machine 120 which may in turn provide a generator function to convert the engine output to electrical energy, where the electrical energy may be stored at energy storage device 150 for later use by the motor.

The fuel system 140 may include one or more fuel storage tanks 144 for storing fuel on-board the vehicle. For example, the fuel tank(s) 144 may store one or more gaseous and/or liquid fuels, including but not limited to gasoline, diesel, natural gas, or hydrogen. The fuels in storage tanks 144 may be delivered to the engine 110 as indicated by arrow 142, where they may be combusted at the engine to produce an engine output. The engine output may be utilized to propel the vehicle as indicated by arrow 112 or to recharge the energy storage device 150 via the electric machine 120 and/or the generator 160. The engine 110 and the other engines described herein may be configured for compression and/or spark ignition, for example.

In some embodiments, the energy storage device 150 may be configured to store electrical energy that may be supplied to other electrical loads residing on-board the vehicle (other than the motor), including cabin heating and air conditioning, engine starting, headlights, cabin audio and video systems, etc. As a non-limiting example, the energy storage device 150 may include one or more batteries and/or capacitors. The energy storage device 150 may further include a battery management system (BMS) communicatively coupled to the controller 191. The BMS may be configured to control the energy storage device 150 independently of and in cooperation with the controller 191. The BMS may monitor one or more voltages, currents, and temperatures of the energy storage device 150 via electrical signals produced by corresponding sensors. For example, the BMS may provide SOC and state of health (SOH) information to the controller 191 via electrical signals. As a reaction to the monitored voltages, currents, and/or temperatures of the energy storage device 150 (e.g., of each battery cell and/or capacitor thereof) fluctuating in predetermined patterns and/or amounts, or as a reaction to receiving a command signal from the controller 191, the BMS may adjust operation of the energy storage device 150 by sending control commands to actuators thereof, including circuit breakers and contactors, fans and other cooling equipment, and the like. Adjusting the actuators in this way may change the maximum output current of the energy storage device 150, increase cooling intensity (e.g., fan speed) to reduce the temperature, control which battery cells of the energy storage device 150 are being charged/discharged, etc.

The energy storage device 150 may further be configured to provide power to the external load 106 when electrically coupled. For example, the energy storage device 150 may be electrically coupled to one or more electrical devices 108 (e.g., refrigerator, lamp, cooking appliance, fan, space heater, etc.), as indicated by arrow 126. Additionally or alternatively, the energy storage device 150 may be electrically coupled to an electrical panel 118 as indicated by arrow 128. For example, the electrical panel 118 may connect circuits of a house or other building that receives power from an electrical grid. The energy storage device 150 and the electrical panel 118 may be electrically coupled via a transfer switch (e.g., switch that decouples the electrical grid from the external load 106 and couples the electrical panel 118 to the vehicle 101), as one example. In another example, the energy storage device 150 may be electrically coupled to the electrical panel 118 via a bidirectional power transfer connection where power may flow from the energy storage device 150 to the electrical panel 118 and vice versa. The electrical devices 108 may receive power from the electrical panel 118 as indicated by arrow 132, for example via branch circuits. The electrical panel 118 may further provide power to lights, HVAC, and/or other systems integral to the building (e.g., house or other electrical system equipped structure). The electrical couplings indicated by arrows 126, 128, 132 may be physical (e.g., wired), wireless, or a combination thereof. Thus, the vehicle 101 may be used to power the external load 106 when electrically coupled, for example in response to a power outage experienced by the external load 106.

The vehicle 101 may further include a cooling system 134 adapted to cool the vehicle 101, including one or more of the engine 110, the generator 160, the electric machine 120, the energy storage device 150 and the fuel system 140. The cooling system 134 may comprise subsystems each adapted to cool a part of the vehicle 101. For example, the cooling system 134 may include a first subsystem for cooling the energy storage device 150, a second subsystem for cooling the electric machine 120, and/or a third subsystem for cooling the engine 110, etc. The cooling subsystems may be individually activated and controlled, in some examples. The cooling system 134 may comprise one or more fans for air circulation. Additionally or alternatively, the cooling system 134 may actively flow (e.g., pump) coolant fluid (e.g., oil) through and/or around components of the vehicle 101. Other means of cooling are also possible, additionally or alternatively to the exampled provided herein. The cooling system 134 may be operated to maintain temperatures of the vehicle systems below temperature thresholds where efficiency of the system decreases (e.g., energy conversion efficiency of the motor may decrease as temperature increases beyond a temperature threshold) or thermal degradation may occur. The cooling system 134 may further include temperature sensors, included in sensors 198 of the vehicle 101, configured to detect the temperatures of various parts of the vehicle 101 and convey those temperatures to control system 190 via electrical signals. For example, the pulse width of the electrical signal from the temperature sensor may correlate to a temperature.

Control system 190 may communicate with one or more of the engine 110, the electric machine 120, the fuel system 140, the energy storage device 150, the cooling system 134, and the generator 160. Control system 190 may receive sensor feedback (e.g., information from sensors 198 in the form of electrical signals) from one or more of the engine 110, the electric machine 120, the fuel system 140, the energy storage device 150, the cooling system 134, and the generator 160. Further, control system 190 may send control signals to one or more of the engine 110, the electric machine 120, the fuel system 140, the energy storage device 150, the cooling system 134, and the generator 160 responsive to this sensor feedback. Additionally, control system 190 may be configured to send and receive sensor feedback to/from a refueling station and/or electric charging apparatus. The control system 190 may receive an indication of an operator requested output of the vehicle propulsion system from a vehicle operator 102. For example, the control system 190 may receive sensor feedback from a pedal position sensor 189 of the sensors 198 which communicates with a pedal 187. The pedal 187 may refer schematically to a speed adjustment pedal.

The control system 190 includes a controller 191. The controller 191 is shown in FIG. 1 as a conventional microcomputer including: microprocessor unit 192, input/output ports 193, read-only memory 194 (e.g., non-transitory memory), random access memory 195, keep alive memory 196, and a conventional data bus. Controller 191 is shown receiving various signals from sensors 198 coupled to engine 110, in addition to those signals previously discussed, including: engine coolant temperature (ECT) from temperature sensor coupled to a cooling sleeve; a position sensor coupled to an driver demand pedal for sensing force applied by human foot; a position sensor coupled to caliper control pedal for sensing force applied by foot, a measurement of engine manifold pressure (MAP) from pressure sensor coupled to intake manifold; an engine position sensor from a position sensor sensing crankshaft position; a measurement of air mass entering the engine from sensor; and a measurement of throttle position from a sensor. Barometric pressure may also be sensed for processing by controller 191. A position sensor may produce a predetermined number of equally spaced pulses each revolution of the crankshaft from which engine speed (RPM) can be determined.

The controller 191 may receive various signals from sensors coupled to the engine 110, including measurement of manifold airflow pressure (MAP) sensor; engine coolant temperature (ECT) from temperature sensor exhaust gas air/fuel ratio from exhaust gas sensor; a crankcase pressure sensor (CKCP); BP sensor, TIP sensor, etc. Furthermore, the controller may monitor and adjust the position of various actuators based on input received from the various sensors. These actuators may include, for example, the throttle, and intake and exhaust valve systems. Storage medium read-only memory 194 can be programmed with computer readable data representing instructions executable by processor 192 for performing the methods described below, as well as other variants that are anticipated but not specifically listed.

The energy storage device 150 may periodically receive electrical energy from a power source 180 residing external to the vehicle (e.g., not part of the vehicle) as indicated by arrow 184. As a non-limiting example, vehicle propulsion system 104 may be configured as a plug-in HEV, whereby electrical energy may be supplied to energy storage device 150 from the power source 180 via an electrical energy transmission cable 182. During a recharging operation of the energy storage device 150 from the power source 180, the electrical transmission cable 182 may electrically couple the energy storage device 150 and the power source 180. While the vehicle propulsion system 104 is operated to propel the vehicle, electrical transmission cable 182 may be disconnected between the power source 180 and the energy storage device 150. The control system 190 may identify and/or control the amount of electrical energy stored at the energy storage device, which may be referred to as the state of charge (SOC).

In other embodiments, the electrical transmission cable 182 may be omitted, where electrical energy may be received wirelessly at the energy storage device 150 from the power source 180. For example, the energy storage device 150 may receive electrical energy from the power source 180 via one or more of electromagnetic induction, radio waves, and electromagnetic resonance. As such, it should be appreciated that any suitable approach may be used for recharging energy storage device 150 from a power source that does not comprise part of the vehicle, such as from solar or wind energy. In this way, the electric machine 120 may propel the vehicle by utilizing an energy source other than the fuel utilized by the engine 110.

The fuel system 140 may periodically receive fuel from a fuel source residing external to the vehicle. As a non-limiting example, the vehicle propulsion system 104 may be refueled by receiving fuel via a fuel dispensing device 170 as indicated by arrow 172. In some embodiments, fuel tank 144 may be configured to store the fuel received from the fuel dispensing device 170 until it is supplied to the engine 110 for consumption (e.g., combustion). In some embodiments, control system 190 may receive an indication of the level of fuel stored at the fuel tank 144 via a fuel level sensor of the sensors 198. The level of fuel stored at the fuel tank 144 (e.g., as identified by the fuel level sensor, which may correspond to a pressure sensor in the case of a gaseous fuel) may be communicated to the vehicle operator 102, for example, via a fuel gauge or indication in a vehicle instrument panel 197.

The sensors 198 of the vehicle propulsion system 104 may also include an ambient temperature/humidity sensor, and the like. The vehicle instrument panel 197 may include indicator light(s) and/or a text-based display in which messages are displayed to an operator. The vehicle instrument panel 197 may also include various input portions for receiving an operator input, such as buttons, touch screens, voice input/recognition, etc. Additionally or alternatively, the control system 190 may be communicatively coupled (e.g., wirelessly) to a personal wireless device 136 configured to display messages to the operator and/or receive operator input. For example, the vehicle 101 may be equipped with a telematics system configured for wireless connection with wireless services over cellular, Wi-Fi™, and/or Bluetooth®. The vehicle 101 may be communicatively coupled to a wireless network 138 comprising one or more of wireless telephone networks, wireless local area networks. The wireless network 138 may allow communication between the vehicle 101 and other telematics-equipped vehicles, cellular phones, satellites, etc. Information received by the controller 191 over the wireless network 138 may trigger execution of methods described below.

Turning to FIG. 2A, a method 200 for providing electrical power from a vehicle (e.g., vehicle 101 of FIG. 1) to an external load (e.g., external load 106 of FIG. 1) is shown as a flowchart. Instructions for carrying out method 200 and the rest of the methods included herein may be executed by a controller (e.g., controller 191 of FIG. 1) based on instructions stored on a non-volatile memory of the controller and in conjunction with signals received from sensors of the vehicle, such as the sensors described above with reference to FIG. 1. The controller may employ actuators of the vehicle to adjust vehicle operation, according to the methods described below. Some steps of the method 200 may be completed manually by an operator, as described below. Additionally or alternatively, the method 200 may be executed by a processor of a wireless device (e.g., cellular phone) in communication with the vehicle in conjunction with the controller of the vehicle according to instructions of an application installed in non-volatile memory of the wireless device.

The method 200 begins at 202, wherein a power outage to an external load is determined, and a duration of the power outage, also referred to herein as the predicted power outage duration, is predicted. The power outage to the external load may occur due to a disruption between the electrical connection between the electrical grid and the external load. The power outage may be determined by the controller analyzing cloud sourced data including local government/media alerts, social media posts, and energy services notifications. For example, referencing FIG. 1, the controller 191 may receive such information via communication with various systems and devices (e.g., other vehicles, the personal wireless device 136, automatic government and energy services notification systems, etc.) over the wireless network 138. Such information may also be used to predict the power outage duration. Alternatively, the controller may determine a power outage to the external load in response to manual input. For example, referencing FIG. 1, the user may notify the controller 191 via input to the personal wireless device 136 or the instrument panel 197 that a power outage to an external load in the vicinity of the vehicle 101 is starting or occurring, and may manually choose a predicted end time of the power outage. As another example where the vehicle is electric or hybrid, the vehicle may detect a power outage to the external load when connected to a charging system (e.g., power source 180) that is electrically coupled to the external load and selectively electrically coupled to the vehicle (e.g., via the electrical energy transmission cable 182) experiences loss of power. That is, absence or pause of power flow from the charging system to the vehicle may indicate the charging system (and therefore the external load) are experiencing a power outage.

The power outage duration may be predicted by similar means. For example, information related to government/media alerts, social media posts, and/or energy services notifications received over the wireless network may contain information as to an expected end time of the power outage. The predicted power outage duration may be automatically updated periodically and/or in response to receiving additional information. For example, an initial expected end time of the power outage may be predicted at a first time, and at a later time than the first time, the expected end time of the power outage may be updated according to information received between the first time and the later time. In this way, the status of the power outage may be updated in real-time or near real-time, informing the user of changes to the predicted power outage duration via a passive display and/or notifications.

The method 200 proceeds to 204, wherein the vehicle is automatically prepared for electrical power transfer from the vehicle to the external load and a user is alerted. In some examples, the user may be alerted of the power outage, prompting the user to provide input that powers on the vehicle and subsequently allows automatic initialization of various systems of the vehicle. In other examples, the automatic preparation may be performed without prior user intervention such that in response to detection of the power outage, the controller may automatically send command signals to various actuators of the vehicle to prepare the vehicle for power draw from the vehicle to the external load. In this way, the vehicle may be automatically prepared to supply power to the external load prior to being electrically coupled to the external load. For example, the cooling system 134 of FIG. 1 may be automatically activated to counteract the effects of excessive heat produced under high current electrical flow from the vehicle to the external load. By beginning cooling the vehicle prior to flowing electricity therefrom, the cooling system may be able to maintain the components of the vehicle below their corresponding threshold temperatures where above which degradation or loss of efficiency may occur. Thus, despite the vehicle being stationary when electrically coupled to the external load during power flow in subsequent steps of the method 200 which eliminates passive thermal maintaining effects of air flow surrounding the vehicle, overheating (e.g., heating one or more components beyond their corresponding threshold temperatures) may be prevented. For example, referencing FIG. 1, command signals generated by the controller may cause the cooling system 134 to begin cooling the energy storage device 150, the engine 110, and the electric machine 120 via fans, coolant fluid flow, etc. In this way, the reduced thermal management capability of a stationary vehicle compared to a moving vehicle (e.g., due to the moving vehicle being passively cooled by motion relative to the surrounding air and/or the stationary vehicle being located in a closed and insulated environment such as a garage) may be at least partially mitigated by preemptively initiating cooling procedures. As another example of automatically preparing the vehicle in response to determining the power outage, the controller may send command signals to the energy storage device that cause circuit breakers and contactors to open and close automatically to appropriate positions for power transfer from the vehicle, such as to allow a desired number of battery cells to discharge to a port where electrical energy may be withdrawn from the vehicle, to set a maximum current flow, etc. As another example of automatically preparing the vehicle, the controller may send command signals which enable trunk outlets (e.g., enable power flow from the vehicle via the trunk outlets). If after a predetermined amount of time from being automatically enabled, the trunk outlets are not utilized, the controller may further generate command signals which automatically disable the trunk outlets to reduce excess power draw from the inverter. Interior outlets may be automatically prepared in a similar manner.

Further, in response to the detection of the power outage to the external load, the controller may automatically generate an alert which notifies the user of the power outage. For example, the alert may be displayed in visual and/or audio formats of the instrument panel 197 and/or the personal wireless device 136. The alert may prompt the user to confirm the intention to power the external load with the energy stored in the vehicle (e.g., as fuel and/or battery charge). If the user indicates powering the external load via the vehicle energy is not desired, the method may end. Alternatively, for example if the user confirms, the user may be further prompted to input the intended type of electrical connection between the external load and the vehicle that is formed at a subsequent step of the method 200, such as via a transfer switch, bi-directional power transfer (BPT), direct to appliances, etc. In response to such inputs regarding the electrical connection, the display may be updated with instructions for electrically coupling the external load and the vehicle, such as types of cables, corresponding locations of connection ports (e.g., electrical outlets, transfer switch, etc.) and suggested steps to reduce a likelihood of (e.g., prevent) degradation to components of the vehicle, external load, power transfer cables, and/or other equipment involved in power flow between the vehicle and the external load. The alert may further prompt the user to input information used in executing subsequent steps of the method 200, such as types of appliances and systems of which the external load is comprised (e.g., lights, HVAC, cooking appliances, etc.), in order to estimate a predicted power demand of the external load at subsequent steps of the method 200.

The method 200 proceeds to 206, wherein an available vehicle energy and a threshold vehicle energy are determined, the threshold vehicle energy being based on a travel distance to repower as described further below. The available vehicle energy of the vehicle may be calculated based on the battery SOC (e.g., percentage of a maximum energy storage capacity of the energy storage device 150) and/or the fuel level (e.g., amount of fuel remaining in the fuel storage tanks 144). The battery SOC and/or the fuel level may be measured by sensors of the vehicle and communicated to the controller of the vehicle via electrical signals, such as described above with reference to FIG. 1. The controller may process the electrical signals algorithmically as described below to determine the available vehicle energy and other variables dependent thereon. The available vehicle energy of an electric vehicle may be based on the battery SOC only, and the available vehicle energy of a hybrid vehicle may be based on both the battery SOC and the fuel level. Specifically, the battery SOC may be converted to an amount of energy stored in the battery and/or the fuel level may be converted to an amount of electrical energy generable by consuming (e.g., combusting) the amount of fuel, referred to herein as the fuel energy. The available vehicle energy may be a function of the battery capacity and/or the fuel energy. For example, for a hybrid vehicle, the available vehicle energy may be a sum of the battery capacity and the fuel energy. A factor may be applied to one or both of the battery capacity and the fuel energy (e.g., before and/or after summation) to adjust for efficiency losses (e.g., energy lost as heat) during energy conversion (e.g., mechanical energy converted to electrical energy) and/or energy transmission (e.g., throughout the vehicle and to the external load along pathways described in regard to FIG. 1).

The threshold vehicle energy may be a non-zero positive value equal to or greater than a predicted amount of vehicle energy (e.g., energy stored as fuel and/or charge of the energy storage device) demanded to propel the vehicle the travel distance to repower the vehicle. The distance to repower may be a distance to the nearest repowering (e.g., refueling and/or recharging) station determined according to user input (e.g., into a navigation system of the vehicle having access to locations of fuel and/or charge stations), or information received via a wireless network similar to the means for determining the power outage to the external load. A powering station that is experiencing the power outage may not be selected as the nearest repowering station such that only powering stations readily available to provide power are considered in determining the nearest one. For example, the controller may determine an energy efficiency of the vehicle (e.g., distance travelable per amount of decrease in available vehicle energy) from data gathered during previous operation of the vehicle and/or a default stored in non-volatile memory of the controller. The threshold vehicle energy may be equal to or greater than the travel distance to repower divided by the determined energy efficiency. As such, so long as the available vehicle energy is greater than the threshold vehicle energy, the vehicle may be repowered at the repowering station located the distance to repower away from the current location of the vehicle. Because the distance to repower is dependent on the locations of the nearest repowering station and the vehicle, the distance to repower may be updated when either changes. For example, the vehicle may be driven to a different location, prompting an update to the distance to repower. As another example, the nearest repowering station may change, for instance due to nearer charging stations that experienced the power outage regaining power, prompting an update to the distance to repower. Because the distance to repower is variable, the threshold vehicle energy may also change throughout the power outage duration. For example, the threshold vehicle energy may be updated periodically and/or in response to change such as change in the distance to repower.

The method proceeds to 208, wherein the external load is electrically coupled to the vehicle. More specifically, the external load may be electrically coupled to an energy storage device of the vehicle. Electrically coupling may be performed manually rather than automatically, in at least some examples. In examples where instructions for electrical coupling are provided at 204 in response to user input, the user may follow the instructions to electrically couple the vehicle to the external load. For example, electrically coupling the vehicle and the external load may include a user manually connecting an electrical energy transmission cable (e.g., similar to the electrical energy transmission cable 182 of FIG. 1) to the energy storage device at one end and to the external load at the other end. Electrically coupling the external load and the vehicle may enable energy transfer (e.g., electrical power flow) therebetween. The vehicle and the external load may be electrically coupled automatically and/or via a wireless connection without departing from the scope of the present disclosure.

After establishing the electrical coupling between the vehicle and the external load, the method 200 proceeds to 210, wherein electrical power is flowed from the vehicle to the external load while the available vehicle energy of the vehicle and power consumption of the external load are monitored. Flowing electrical power from the vehicle to the external load may occur as controlled by the controller of the vehicle by sending command signals to adjust circuit breakers to selectively allow the flow of electrical power out of the vehicle.

Flowing electrical power from the vehicle to the external load may reduce the available vehicle energy by approximately the amount of energy being consumed by the external load. Thus, the available vehicle energy may be updated during power flow. For example, the available vehicle energy may be recalculated as described with regard to step 206 on a preset interval (e.g., every minute), or in response to stimuli during power flow, such as a change in power consumption of the external load (e.g., due to an additional electrical device being powered on or off, change in temperature setting on HVAC system, etc.). For example, the fuel level and the battery SOC as indicated by electrical signals from corresponding sensors may be used by the controller to calculate the current available vehicle energy. Additionally or alternatively, a rate of decrease of the available vehicle energy may be calculated from the rate of fuel usage (e.g., volumetric decrease of liquid fuel or pressure decrease of gaseous fuel in fuel storage) and/or the rate of battery SOC decline. The controller may estimate the available vehicle energy according to the calculated rate of decrease for a period of time to decrease executions of algorithmic operations to refresh the available vehicle energy, thereby conserving computational power demanded by the controller.

Similarly, though not directly measureable, power consumption of the external load may be monitored by sensors of the vehicle. For example, sensors of the energy storage device may send electrical signals to the controller communicating a change in current or voltage within the energy storage device that is interpretable to determine a change in power consumption of the external load. As an example, an increase in electrical current flow detected by a current sensor (e.g., current flowing out of the energy storage device) may indicate an increase in power consumption of the external load. As another example, as described above, the controller of the vehicle may cooperate with a BMS of the energy storage device in order to control aspects of the energy storage device and request information regarding sensor signals of the energy storage device. That is, electrical signals sent from the sensors of the energy storage device may be received by the BMS which may in turn communicate with the controller of the vehicle. The BMS may monitor the SOC of the energy storage device according to the energy storage device sensors and communicate the SOC to the controller of the vehicle via electrical signals. The rate of change of the SOC may be directly related to the power consumption of the external load. That is, an increase in the rate of SOC depletion may indicate a proportional increase in the power consumption of the external load. The determined changes in power consumption of the external load may be used to update the predicted power demand of the external load. For example, the predicted power demand of the external load may be updated periodically to reflect the current power consumption of the external load.

Electrical power may continue to flow out of the vehicle until specified otherwise in successive steps of the method 200. While electrical power is supplied to the external load, fuel may be consumed (e.g., combusted) by the engine to transform energy into an electrical form (e.g., by operating a generator as described above with reference to FIG. 1) in order to replenish the electrical power supply provided to the external load (e.g., charge of energy storage device), in examples where an engine is included in the vehicle (e.g., hybrid vehicle). In some examples, preparing the vehicle (e.g., at 202) may include initiating consumption of the fuel prior to electrical power flow. In such an example, a greater supply of electrical energy may be readily available for direct consumption by the external load prior to electrically coupling the vehicle and the external load due to less potential energy being stored in the fuel. Additionally or alternatively, the engine, if included, may operate at a lower intensity (e.g., lower fuel consumption rate) by extending the period of fuel consumption to before power flow, reducing a temperature of the engine and therefore a likelihood of the temperature of the engine exceeding a corresponding threshold.

The method 200 proceeds to 212, wherein an available duration until the available vehicle energy reaches the threshold vehicle energy is calculated based on the predicted power demand of the external load. For example, the available duration may be equivalent to a difference between the available vehicle energy and the threshold vehicle energy divided by the predicted power demand. The available duration may be displayed for view by the user similarly to displaying the alert generated at 204, for example via a display screen of the vehicle or a personal wireless device in communication with the vehicle. The predicted power outage duration may be compared to the available duration in subsequent steps of the method described below to inform the user of whether or not the available vehicle energy is enough to reach the predicted end time of the power outage to the external load. By providing the available duration in this way, the user may be made aware of the power capabilities of the vehicle in the current state, and may make informed decisions as to whether to repower the vehicle (e.g., travel the distance to repower in order to recharge and/or refuel), reduce power consumption (e.g., disconnect part of the external load such as by unplugging an electrical appliance, adjusting temperature settings on an HVAC system, or turning off a light switch), etc. in order to prolong the available duration sufficiently, reducing a likelihood of lack of vehicle power supply prior to the end of the power outage.

Moving on to FIG. 2B where the method 200 continues following 212, the method 200 proceeds to 222, wherein it is determined whether the predicted power outage duration is longer than the available duration, and/or a temperature of at least one component of the vehicle is greater than a corresponding threshold temperature. The predicted power outage duration and the available duration as calculated in preceding steps of the method 200 may be simply compared to determine which is greater. Comparing the temperatures to their corresponding thresholds may include receiving electrical signals from one or more temperature sensors positioned throughout the vehicle as described above, interpreting the electrical signals to determine the temperatures of the positions (e.g., according to relationship with signal pulse width), and comparing the temperatures to the temperature thresholds stored in non-volatile memory of the controller. For example, components of the vehicle may be thermally monitored separately, and may each have a temperature threshold. Each temperature may be detected by a temperature sensor and communicated to the controller via electrical signals. The controller may compare the thresholds to the corresponding temperatures to determine whether at least one of the temperatures has exceeded the corresponding temperature threshold. As an example, an electric motor of the vehicle may have a first temperature threshold, an engine of the vehicle may have a second temperature threshold, a battery of the vehicle may have a third temperature threshold, etc. The first, second, and third temperature thresholds may be different from each other, or may be approximately equal. The temperature thresholds may be chosen to be at or below temperatures where degradation to the corresponding components may occur and may be preprogrammed into non-volatile memory of the controller. As described above, preparing the vehicle for power transfer at 202 by initiating cooling systems may reduce the likelihood of the temperatures exceeding the corresponding thresholds. However, under high power transfer, one or more of the temperatures may surpass the corresponding threshold due to the lack of passive cooling occurring as the vehicle is stationary and/or located in an enclosed space (e.g., garage) during power transfer.

If the predicted power outage duration is longer than the calculated available duration and/or the temperature is greater than the corresponding temperature threshold (YES at 222), the method 200 proceeds to 224, wherein an alert is generated and power consumption of the external load is reduced. The power consumption may be reduced automatically or manually. For example, the controller may automatically cause adjustments to vehicle circuitry to reduce the power leaving the vehicle. More specifically, the controller may send command signals to actuators of the energy storage device (e.g., circuit breakers and contactors) to reduce current flowing therefrom. If the power consumption is automatically reduced, the controller may generate the alert to notify the user of the vehicle that the power consumption is reduced. Additionally or alternatively, in response to the alert recommending to the user to reduce power consumption, the user may unplug an appliance, turn off a light switch, etc. in order to reduce power drawn from the vehicle to the external load. The resulting reduction in power consumed by the external load may cause the controller to update the predicted power demand of the external load.

After 224, the method 200 returns to 222. In this way, the power usage may continue to be reduced until the available duration is greater than the predicted power outage duration and the measured temperatures of the vehicle are below the corresponding thresholds.

If the predicted power outage duration is shorter than the calculated available duration and the temperatures of the vehicle are below their corresponding temperature thresholds (NO at 222), the method 200 proceeds to 226, wherein it is determined whether the power outage is ended, or the available vehicle energy is less than the threshold vehicle energy. The end of the power outage may be detected by any of the same methods for detecting the beginning of the power outage described above, such as analysis of cloud sourced data received over a wireless network.

If the available vehicle energy is less than the threshold vehicle energy and/or the power outage is ended (YES at 226), the method 200 proceeds to 228, wherein the user may choose whether to override a power stop. For example, the user may be alerted of the detected end of the power outage or the available vehicle energy falling below the threshold vehicle energy and prompted to choose whether to override the power stop. User input (e.g., selection on touch screen, button pressed, voice command, etc.) may indicate whether or not the user desires to override the power stop or not. Depending on the result of 228, the power stop may include automatically stopping the power flow from the vehicle to the external load as a response to detecting the end of the power outage or the available vehicle energy falling below the threshold vehicle energy, as described further below. Absence of user input may be interpreted as not overriding the power stop. That is, the default response to the condition determined at 226 may be to automatically stop power flow unless user input is received commanding otherwise within a given time of generating the alert. For example, the user may override the power stop in the case that repowering the vehicle is not desired, such as when the available vehicle energy is enough to power the vehicle until the expected end of the power outage but not to propel the vehicle the distance to repower.

If the user overrides the power stop (YES at 228), or if the available vehicle energy is greater than the threshold vehicle energy and an end of the power outage is not detected (NO at 226), the method 200 proceeds to 230, wherein electrical power continues to flow from the vehicle to the external load while the available vehicle energy and the predicted power demand of the external load are monitored as described above. After overriding the power stop, the available vehicle energy may not be considered in the conditions of 226 when repeated at a later time. As described above, consumption of fuel may also continue during power flow, if applicable. Monitoring may include periodically updating the available vehicle energy and the available duration. The available duration may decrease proportionally with time throughout power flow, unless changes occur to the threshold vehicle energy, as illustrated in the timeline diagram of FIG. 3 and described below.

After 230, the method 200 returns to 222. In this way, power may continue to be supplied to the external load while the predicted power outage duration, available duration, available vehicle energy, and available duration are monitored (e.g., detected, recalculated, etc.) until the power outage ends or the available vehicle energy falls below the threshold vehicle energy.

Alternatively, if the user does not override the power pause (NO at 228), the method 200 proceeds to 232, wherein flow of electrical power from the vehicle to the external load is automatically stopped. For example, the controller of the vehicle may send command signals to actuators of the energy storage device to decouple the vehicle from the external load without manual intervention (e.g., manual unplugging of electrical power transmission cables from the vehicle and/or external load). For example, a circuit breaker may disrupt the electrical coupling, responsive to the aforementioned command signals. Further, an alert may be generated to notify the user that to continue powering the external load, repowering the vehicle at the nearest repowering station the distance to repower away from the current location of the vehicle may be demanded. The method 200 ends after 232.

Variations of the method 200 are also possible without departing from the scope of the present disclosure, including different orders of the steps, additional or alternative steps, or omitted steps. In one example, the power demand of the external load may be predicted prior to starting power transfer, for example according to the user input received in response to the alert generated when the power outage is determined. As an example, the user input may indicate that the external load includes lights and a refrigerator. A power demand value may be assigned to each of the lights and the refrigerator, and summed to produce a predicted power demand. For example, the power demand values may be found in lookup tables stored in the memory of the controller containing standard power consumption of common electrical devices. Alternatively, for example if the user declines to provide input, a default estimate of predicted power demand of an external load stored in memory of the controller may be used, such as an average amount of power used to power a house. The average amount of power may be chosen according to the geographical region, time of year, etc. Upon initiating power flow in subsequent steps of the method, the predicted power demand may be updated according to electrical signals from sensors of the vehicle periodically (e.g., on a preset interval or in response to stimuli such as a change in sensor readings). In such an example, the available duration may be predicted prior to initiating power flow from the vehicle to the external load.

Turning to FIG. 3, a timeline diagram 300 is shown, including example events of interest occurring while providing power from a vehicle to an external load via the systems and methods described herein. Time increases to the right along the horizontal axes of the timeline diagram 300.

A first plot 302 shows the available vehicle energy and the threshold vehicle energy as indicated by a first trace 312 and a second trace 320, respectively. The available and threshold vehicle energies may be calculated and updated by the controller as described herein. A second plot 304 shows the predicted power demand of the external load as indicated by a third trace 314. The predicted power demand may be determined according to the actual power consumed by the external load as measured periodically or continuously by current sensors of the vehicle, but may not always be equal to the actual power consumed. For example, the controller may update the predicted power demand on a set interval and/or in response to a detected change in magnitude of electrical energy leaving the vehicle such that for a period of time between updates, the predicted power demand is not equal to the power consumed by the external load. A third plot 306 shows the available duration and the predicted power outage duration as indicated by a fourth trace 316 and a fifth trace 318, respectively. The durations (e.g., the available duration and the predicted power outage duration) may decrease with constant slope due to time increasing linearly on both the vertical and horizontal axes of the plot 306. Thus, time is shown increasing uniformly along the horizontal axes of the plots 302, 304, 306. However, it will be understood that the intervals between times may be different than shown. For example, the time between events described as occurring at t0 and t1 may be relatively shorter or longer than any of the other time intervals (e.g., t1 to t2, t2 to t3, t3, to t4, t4 to t5, t5 to t6, and t6, to t7). Further, the events represented in the timeline diagram 300 may occur in different temporal orders than described in this example due to the iterative algorithmic nature of at least some parts of the methods executed by the controller of the vehicle. For example, events described as taking place during an interval between t3 and t4 may occur in other examples before events described as taking place during an interval between t1 and t2. The traces 312, 314, 316, 318, 320 may indicate relative quantities and changes, rather than quantitative values.

At t0, a power outage to the external load is detected, prompting automatic preparation of the vehicle, generation of an alert, and prediction/calculation of values including the power demand of the external load, the power outage duration, the available vehicle energy, and the available duration. For example, steps of the method 200 of FIGS. 2A and 2B may be executed in response to the power outage being detected. Specifically, the vehicle may automatically prepare for power transfer (e.g., by activating cooling systems, fuel consumption, and/or setting circuit breakers to prime the vehicle electrical system for power transfer), and generate an alert of the power outage to be displayed to a user (e.g., audio and/or visual message produced by a personal wireless device or instrument panel of the vehicle). Preparing the vehicle for power transfer by precooling components susceptible to overheating under high current conditions and/or initiating fuel consumption to form electrical energy therefrom may reduce a likelihood of reduced efficiency and degradation to such components due to overheating during power transfer. In response to the alert, the user may input types of devices and systems (e.g., lights, HVAC, cooking appliances, etc.) of the external load intended to be powered via energy from the vehicle and/or an intended means of electrical connection between the vehicle and the external load (e.g., transfer switch, BPT, direct cable plug-in, or the like). A set of instructions for forming the intended electrical connection may be provided to the user via further messages generated by the personal wireless device or instrument panel, as an example. In this way, the user may be more likely to form the electrical coupling without manual error.

The available vehicle energy and the available duration are shown as constant values prior to power flow between the vehicle and the external load being initiated (e.g., at t1), as the energy use during preparation (e.g., to run cooling systems) may be negligible compared to the power demand of the external load. Further, the available duration may be a prediction based on the user input of the types of devices and systems of the external load or a default expected power demand. After power flow is initiated at a later time, the available duration may be based on measured power usage. The predicted available duration, shown as the segment of trace 316 between t0 and t1, is greater than the predicted power outage duration. Thus, it may be concluded that the vehicle possesses enough energy stored as fuel and/or electrical power charge to power the vehicle for the entire predicted power outage duration or longer.

The vehicle may be manually electrically coupled to the external load between detecting the power outage to the external load and powering the external load with energy of the vehicle (e.g., between t0 and t1). Between t0 and t1, the power demand of the external load is zero as the vehicle is not electrically coupled to the external load during automatic preparation. The predicted power outage duration may decrease according to an estimated time at which the power outage may end. For example, the vehicle may source information (e.g., from location based alerts, social media, etc. via the wireless network) suggesting the power outage may end at t7. Thus, the predicted power outage duration may decrease to reach zero at t7, as shown by extension 324 of trace 318 from t2 (where the expected end time changes to a later time t9 as described below) to t7 with the same slope as from t0 to t2.

Power flow may be initiated at t1, as indicated by the trace 314 increasing to a positive non-zero value for the power demand of the external load, causing a decrease in available vehicle energy, as well as the available duration shown by the traces 312 and 316, respectively.

At t2, the predicted power duration increases, for example due to new information received over the wireless network such as an energy services notification suggesting a later expected end time of the power outage than t7. Due to the extended predicted power duration, the available duration is shorter than the available duration between t2 and t3.

In response to the predicted power outage duration being longer than the available duration, the controller may automatically generate an alert between t2 and t3 to inform the user that not reducing power to the external load may result in loss of power prior to the predicted end of the power outage. The alert may provide recommendations as to adjustments of the external load that may be sufficient to prolong the available duration beyond the predicted power outage duration. For example, the controller may determine that reducing the power consumption of the external load approximately equal to the standard power consumption of an appliance may increase the available duration enough to exceed the predicted power outage duration, and suggest a corresponding course of action (e.g., powering off and unplugging the appliance) in the alert. Power consumption of the external load may be reduced (automatically or manually as described above) at t3 such that the available duration is longer than the predicted power outage duration. For some examples, the power consumed by the external load may be reduced automatically by the controller generating a command signal to adjust circuitry in the vehicle to limit current flow out of the vehicle, and/or manually by the operator disconnecting a portion of the external load from the vehicle as a reaction to observing the alert generated by the controller (e.g., by unplugging an appliance of the external load from an outlet electrically coupled to the vehicle, switching off a light, etc.).

At t4, the power demand of the external load increases, causing a more rapid decrease in the available vehicle energy as shown by trace 312 increasing negative slope. Without a decrease in power demand of the external load, the available vehicle energy would fall below the threshold vehicle energy prior to the predicted end of the power outage, as shown by the line 322 extending from t2 with the same slope as trace 312 between t1 and t2 to the threshold vehicle energy at a time (e.g., t6) on the horizontal axis before (e.g., to the left of) the current predicted end time of the power outage (e.g., t8).

As a result, the power flow to the external load is reduced at t5, automatically or manually as described above, reducing the rate of the decrease in the available vehicle energy, and increasing the available duration. The available duration is greater than the predicted power outage duration between t5 and t8, so power continues to flow from the vehicle to the external load. Although shown as constant between t5 and t8, it may be that the power demand of the external load fluctuates within bounds that maintain the available duration longer than the predicted power outage duration.

At t8, the available vehicle energy falls below the threshold vehicle energy (and equivalently, the available duration reaches zero) triggering generation of an alert to the operator and automatic stopping of the power flow from the vehicle to the external load. Thus, at t8, the power consumed by the external load drops to zero. Further, at t8, the predicted end time of the power outage is updated to t11, as the end of the power outage is not detected. Between t8 and t9, the available vehicle energy and the available duration continue to decline as the vehicle is propelled (e.g., driven) the travel distance to repower (e.g., refuel and/or recharge) by transforming the available vehicle energy into mechanical energy.

The vehicle may be fueled and/or charged between t9 and t10, increasing the available vehicle energy and accordingly the available duration to the respective maximums, as shown by the traces 312 and 316, respectively. Though not represented in the timeline diagram 300, following t10, the vehicle may be driven back to the external load, or another external load demanding power, which may be electrically coupled to the vehicle in order to receive power from the vehicle following a similar series of events to between t1 and t8, and/or other events executable via the systems and methods disclosed herein.

After t11, the predicted end time of the power outage, the external load may no longer be experiencing a power outage in the case that the predicted end time is approximately the same as the actual end time of the power outage (e.g., the time where the external load regains power input from the electrical grid). Alternatively, the predicted end time of the power outage may be updated (e.g., similar to at t8) and power may continue being provided from the vehicle to the external load until the end of the power outage is detected.

The timeline diagram 300 is a non-limiting example of events that may occur while powering an external load using electrical energy generated and/or stored by a vehicle, and the metrics shown in the timeline diagram 300 may vary differently in practice. For example, in some cases, the available vehicle energy may remain greater than the threshold vehicle energy throughout power transfer. In such an example, charging and/or fueling the vehicle may not be demanded to continue powering the external load until the power outage ends. Further, temperature is omitted from the timeline diagram due to the potentiality of there being several temperatures monitored, each with its own threshold (e.g., a battery temperature threshold, a motor temperature threshold, an engine temperature threshold, etc.), and the ability of temperature to fluctuate independently of the vehicle energy. Thus, though not shown in the timeline diagram 300, automatically stopping power flow from the vehicle due to a temperature exceeding the corresponding threshold may occur as described herein. Further, though the trace 320 is shown as a continuous line, meaning the threshold vehicle energy remains constant (e.g., approximately the same) throughout the timeline diagram 300, it may be that the threshold vehicle energy is updated at a time during power transfer such that part of the trace 320 is shifted upwards or downwards for a higher or lower threshold vehicle energy (e.g., due to a closer or further distance to repower), respectively. In the case where the threshold vehicle energy increases (e.g., due to information received that the nearest repowering station is experiencing the power outage), the increase may cause the available vehicle energy to fall below the threshold vehicle energy. Further still, although the power demand of the external load is shown updating at distinct time points with uneven intervals therebetween (e.g., at t1, t3, t4, t5, and t8), it may be that the predicted power demand of the external load is updated on a shorter, more even interval (e.g., every minute) as opposed to in response to changes in power flow such that the trace 314 resembles a continuous curve rather than discontinuous line segments.

As illustrated by examples herein, the method of operating and performing actions responsive to a determination of a condition may include operating in that condition (e.g., power outage to the external load), determining whether that condition is present (such as based on cloud sourced data, e.g., information received via energy services notifications, social media posts, etc., transmitted over a wireless network) and performing actions in response thereto (e.g., automatically preparing the vehicle for power flow, monitoring available vehicle energy during power flow, and controlling power flow to maintain the available vehicle energy above the threshold vehicle energy), as well as operating without that condition present, determining that the condition is not present (e.g., the end of the power outage to the external load), and performing a different action in response thereto (e.g., automatically stopping power flow).

The technical effect of the systems and methods disclosed herein is to provide electrical power from a vehicle to an external load with reduced likelihood of degradation due to overheating, while controlling power flow to prevent depletion of available vehicle energy of the vehicle prior to an end of the power outage. For example, automatic preparation of the vehicle may increase thermal management capabilities, combating the absence of passively cooling air flow generally present when the vehicle operates in motion. Automatic responses to conditions, such as automatic adjustments to power flow archived by command signals sent to actuators, may further contribute to reduced likelihood of overheating and/or running entirely out of energy of the vehicle. Alerts may be automatically generated in response to conditions to inform a user and/or suggest user actions to supplement the automatic responses, such as to manually reduce power demand of the external load, or to drive the vehicle to be repowered when the available vehicle energy approaches the minimum energy demanded to propel the vehicle to the nearest repowering station. In this way, the vehicle may provide a mobile, self-controlling (e.g., capable of automatically adjusting actuators according to conditions and absence of conditions as detected by sensors of the vehicle) power source for an external load experiencing a power outage from the electrical grid.

The disclosure also provides support for a method for providing electrical power to an external load from a vehicle, comprising: automatically preparing the vehicle for electrical power transfer from the vehicle to the external load and automatically alerting a user when a power outage to the external load is determined, electrically coupling the external load to the vehicle, flowing electrical power from the vehicle to the external load while monitoring an amount of available vehicle energy and a predicted power demand of the external load, and automatically stopping flow of electrical power from the vehicle to the external load when the amount of available vehicle energy falls below a threshold vehicle energy based on a travel distance to repower the vehicle. In a first example of the method, automatically preparing includes automatically activating a cooling system of the vehicle, and one or both of automatically initiating fuel consumption to produce electrical power and automatically preparing an energy storage device for discharge. In a second example of the method, optionally including the first example further including automatically stopping flow of electrical power from the vehicle to the external load when an end of the power outage is determined. In a third example of the method, optionally including one or both of the first and second examples, the threshold vehicle energy is an amount of energy demanded to propel the vehicle the travel distance to repower. In a fourth example of the method, optionally including one or more or each of the first through third examples, the power outage and the end of the power outage are determined according to information received by the vehicle over a wireless network. In a fifth example of the method, optionally including one or more or each of the first through fourth examples, electrically coupling includes connecting an electrical power transmission cable to the vehicle and a transfer switch coupled to the external load. In a sixth example of the method, optionally including one or more or each of the first through fifth examples, the method further comprises reducing power consumption of the external load when a predicted power outage duration is longer than an available duration until the available vehicle energy reaches the threshold vehicle energy.

The disclosure also provides support for a system for electrically powering an external load with a vehicle during a power outage, comprising: an energy storage device of the vehicle, wherein the energy storage device is electrically coupled to the external load, a controller storing on instructions on non-volatile memory that when executed cause the controller to: flow electrical power from the vehicle to the external load, calculate an available duration based on a threshold vehicle energy, an available vehicle energy, and a predicted power demand of the external load, where the threshold vehicle energy is based on a travel distance to repower the vehicle, and generate an alert if a power outage duration is predicted to be longer than the available duration. In a first example of the system, the threshold vehicle energy is approximately equal to an amount of the available vehicle energy expended to propel the vehicle the travel distance to repower. In a second example of the system, optionally including the first example, the energy storage device comprises one or more batteries and/or capacitors. In a third example of the system, optionally including one or both of the first and second examples, the available vehicle energy is equal to an amount of energy stored in the energy storage device. In a fourth example of the system, optionally including one or more or each of the first through third examples, the available vehicle energy is equal to a sum of an amount of electrical energy stored in the energy storage device and an amount of energy stored in fuel consumable by an engine to produce electrical energy. In a fifth example of the system, optionally including one or more or each of the first through fourth examples, the system further includes a wireless device communicatively coupled to the controller via a wireless network. In a sixth example of the system, optionally including one or more or each of the first through fifth examples, the system further includes a cooling system of the vehicle, and the instructions are further executable to automatically activate the cooling system. In a seventh example of the system, optionally including one or more or each of the first through sixth examples, the vehicle is a hybrid or electric vehicle.

The disclosure also provides support for a method for providing electrical power to an external load from a vehicle, comprising: automatically preparing the vehicle for electrical power transfer from the vehicle to the external load and automatically alerting a user when a power outage to the external load is determined, electrically coupling the external load to the vehicle, flowing electrical power from the vehicle to the external load while monitoring an available vehicle energy and a power consumption of the external load, continuing to flow electrical power from the vehicle to the external load while predicting a predicted power outage duration and an available duration, wherein the available duration is based on a threshold vehicle energy and the threshold vehicle energy is based on a travel distance to repower the vehicle, and automatically stopping flow of electrical power from the vehicle to the external load when the available vehicle energy falls below the threshold vehicle energy or when an end of the power outage is determined. In a first example of the method, the threshold vehicle energy is an amount of energy converted to mechanical energy when propelling the vehicle along the travel distance to repower. In a second example of the method, optionally including the first example, the method further comprises predicting a power demand of the external load prior to flowing electrical power. In a third example of the method, optionally including one or both of the first and second examples, the available duration is the amount of time until the available vehicle energy falls below the threshold vehicle energy. In a fourth example of the method, optionally including one or more or each of the first through third examples, the method further comprises reducing power consumption of the external load when the predicted power outage duration is longer than the available duration.

In another representation a hybrid, electric, or ICE vehicle includes: an energy storage device of the vehicle, wherein the energy storage device is electrically coupled to an external load; a controller storing on instructions on non-volatile memory that when executed cause the controller to: flow electrical power from the vehicle to the external load; predict a power outage duration and a predicted power demand of the external load; determine a threshold vehicle energy based on a travel distance to repower the vehicle, and an available vehicle energy of the vehicle; calculate an available duration based on the determined threshold vehicle energy, the available vehicle energy, and the predicted power demand of the external load; and generate an alert if the power outage duration is predicted to be longer than the available duration.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the engine control system, where the described actions are carried out by executing the instructions in a system including the various engine hardware components in combination with the electronic controller.

It will be appreciated that the configurations and routines disclosed herein are exemplary in nature, and that these specific embodiments are not to be considered in a limiting sense, because numerous variations are possible. For example, the above technology can be applied to V-6, I-4, I-6, V-12, opposed 4, and other engine types. Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for providing electrical power to an external load from a vehicle, comprising:
after an external load is electrically coupled to the vehicle, flowing electrical power from the vehicle to the external load while monitoring an amount of available vehicle energy and a predicted power demand of the external load; and
stopping flow of electrical power from the vehicle to the external load when the amount of available vehicle energy falls below a threshold vehicle energy based on a travel distance to repower the vehicle.

2. The method of claim 1, further comprising:
automatically preparing the vehicle for electrical power transfer from the vehicle to the external load;
automatically alerting a user when a power outage to the external load is present;
wherein automatically preparing includes automatically activating a cooling system of the vehicle, and one or both of automatically initiating fuel consumption to produce electrical power and automatically preparing an energy storage device for discharge.

3. The method of claim 2, further including automatically stopping flow of electrical power from the vehicle to the external load when an end of the power outage is determined.

4. The method of claim 2, wherein the threshold vehicle energy is an amount of energy demanded to propel the vehicle the travel distance to repower.

5. The method of claim 3, wherein the power outage and the end of the power outage are determined according to information received by the vehicle over a wireless network.

6. The method of claim 2, wherein electrically coupling includes connecting an electrical power transmission cable to the vehicle and a transfer switch coupled to the external load.

7. The method of claim 2, wherein the method further comprises reducing power consumption of the external load when a predicted power outage duration is longer than an available duration until the available vehicle energy reaches the threshold vehicle energy.

8. A system for electrically powering an external load with a vehicle during a power outage, comprising:
an energy storage device of the vehicle, wherein the energy storage device is electrically coupled to the external load;
a controller storing on instructions on non-volatile memory that when executed cause the controller to:
flow electrical power from the vehicle to the external load; and
generate an alert if a power outage duration is predicted to be longer than an available duration, the available duration based on a threshold vehicle energy, an available vehicle energy, and a predicted power demand of the external load, where the threshold vehicle energy is based on a travel distance to repower the vehicle.

9. The system of claim 8, wherein the threshold vehicle energy is approximately equal to an amount of the available vehicle energy expended to propel the vehicle the travel distance to repower.

10. The system of claim 8, wherein the energy storage device comprises one or more batteries and/or capacitors.

11. The system of claim 8, wherein the available vehicle energy is equal to an amount of energy stored in the energy storage device.

12. The system of claim 8, wherein the available vehicle energy is equal to a sum of an amount of electrical energy stored in the energy storage device and an amount of energy stored in fuel consumable by an engine to produce electrical energy.

13. The system of claim 8, wherein the system further includes a wireless device communicatively coupled to the controller via a wireless network.

14. The system of claim 8, wherein the system further includes a cooling system of the vehicle, and the instructions are further executable to automatically activate the cooling system.

15. The system of claim 8, wherein the vehicle is a hybrid or electric vehicle.

16. A method for providing electrical power to an external load from a vehicle, comprising:
automatically preparing the vehicle for electrical power transfer from the vehicle to the external load and automatically alerting a user when a power outage to the external load is determined;
electrically coupling the external load to the vehicle;
flowing electrical power from the vehicle to the external load while monitoring an available vehicle energy and a power consumption of the external load;
continuing to flow electrical power from the vehicle to the external load while predicting a predicted power outage duration and an available duration, wherein the available duration is based on a threshold vehicle energy and the threshold vehicle energy is based on a travel distance to repower the vehicle; and
automatically stopping flow of electrical power from the vehicle to the external load when the available vehicle energy falls below the threshold vehicle energy or when an end of the power outage is determined.

17. The method of claim 16, wherein the threshold vehicle energy is an amount of energy converted to mechanical energy when propelling the vehicle along the travel distance to repower.

18. The method of claim 16, wherein the method further comprises predicting a power demand of the external load prior to flowing electrical power.

19. The method of claim 16, wherein the available duration is an amount of time until the available vehicle energy falls below the threshold vehicle energy.

20. The method of claim 16, wherein the method further comprises reducing power consumption of the external load when the predicted power outage duration is longer than the available duration.
